(19) United States
(12) Patent Application Publication
(10) Pub. No.: US 2025/0246389 A1
(43) Pub. Date: Jul. 31, 2025

(54) HIGH CURRENT DISCONNECT MODULE

(71) Applicant: Littelfuse, Inc., Chicago, IL (US)

(72) Inventors: James Bugryn, Chicago, IL (US); Brandon Pepa, Chicago, IL (US); Brian Stuckman, Chicago, IL (US); Timothy Piemonte, Chicago, IL (US)

(73) Assignee: Littelfuse, Inc., Chicago, IL (US)

(21) Appl. No.: 18/584,666

(22) Filed: Feb. 22, 2024

Related U.S. Application Data
(63) Continuation-in-part of application No. 18/424,129, filed on Jan. 26, 2024, now abandoned.

(51) Int. Cl. H01H 85/25; H01H 85/02; H01H 85/32

(52) U.S. Cl. CPC H01H 85/25; H01H 85/0241; H01H 85/32

(57) ABSTRACT

A fused disconnect switch may include a fuse carrier to house a fuse, an actuator configured to reversibly engage and disengage with the fuse carrier; a common trip link, mechanically coupled to move in concert with the actuator, and a contact arm, indirectly mechanically coupled to the common trip link. As such, when the fuse carrier is disposed in an engaged position, the contact arm is free to move into a closed position to make electrical contact with a fixed contact, and when the fuse carrier is in a disengage position, the contact arm is prevented from moving into the closed position.

### RELATED APPLICATIONS

This application is a continuation-in-part application, claiming priority to U.S. patent application Ser. No. 18/424,129, filed Jan. 26, 2024, entitled HIGH CURRENT DISCONNECT MODULE, which patent application is incorporated by reference herein in its entirety.

### FIELD

Embodiments relate to the field of protection devices, and in particular, fused disconnect apparatus.

### BACKGROUND

In commercial and industrial power systems, the service entrance power delivery equipment, such as panelboards and the like, is often installed downstream of distribution transformers that are rated to serve a variety of circuits or multiple services. Large transformers fed from the utility will have significant available fault current on the secondary side of the transformer. This circumstance dictates that the power delivery equipment downstream of the transformer have short circuit current ratings (SCCR) to exceed the available fault current of the transformer. Panelboards and switchboards can only have SCCR ratings as high as the interrupting ratings (IR) of the overcurrent devices (OCPDs) that are installed within them—meaning the fuses and circuit breakers.

In the case of ground fault circuit interrupter (GFCI) circuit breakers, the limit is 5kA and 10 kA IR, which values would limit the panelboard SCCR to those respective values. This circumstance forces designers to choose between upstream OCPDs that have been series tested with those GFCI circuit breakers to shield the prospective fault current so that those GFCI circuit breakers are not overdutied. This process can be a complicated selection process and usually limits the designer and user to a single manufacturer for the lifetime of the installation, regardless of any new circuits that may be added or changed. Another drawback to the series combination approach is that the system is inherently not selectively coordinated for high fault currents, especially those currents above the IR of the downstream device. This result means that the user may endure larger outages of their power system in those short circuit situations.

Some advantages afforded by the use of fuses include the high IR, the current limiting capabilities, and ease of coordination. However, fuses may be difficult to replace when needed—de-energizing upstream circuits to create an electrically safe work condition may be required in order to allow installation of a new fuse.

Fused disconnect switches have since been developed to allow for compact fuse installation, with the advantage that just the affected circuit is isolated during fuse replacement. However, the disadvantage of known fused disconnect switches is revealed during multipole and three phase applications. When a ground fault occurs, just the affected phase will clear the fault, leaving the additional phases energized. This circumstance can create unsafe conditions for personnel and equipment if the load remains energized.

In view of the above, the present embodiments are provided.

### BRIEF SUMMARY

In one embodiment, a fused disconnect switch is provided for overcurrent protection. The fused disconnect switch may include a fuse carrier to house a fuse, an actuator configured to reversibly engage and disengage with the fuse carrier; a common trip link, mechanically coupled to move in concert with the actuator, and a contact arm, indirectly mechanically coupled to the common trip link. As such, when the fuse carrier is disposed in an engaged position, the contact arm is free to move into a closed position to make electrical contact with a fixed contact, and when the fuse carrier is in a disengage position, the contact arm is prevented from moving into the closed position.

In another embodiment, a disconnect module is provided. The disconnect module may include a relay module; and a fused disconnect switch, coupled to the relay module. The fused disconnect switch may include a fuse carrier to house a fuse, an actuator configured to reversibly engage and disengage with the fuse carrier; a common trip link, mechanically coupled to move in concert with the actuator, and a contact arm, indirectly mechanically coupled to the common trip link. As such, when the fuse carrier is disposed in an engaged position, the contact arm is free to move into a closed position to make electrical contact with a fixed contact, and when the fuse carrier is in a disengage position, the contact arm is prevented from moving into the closed position.

### BRIEF DESCRIPTION OF THE DRAWINGS

FIG. 1 Shows a cross-sectional view of a fused disconnect switch in a first configuration, according to various embodiments of the disclosure;

FIG. 2 shows the fused disconnect switch of FIG. 1 in a second configuration, according to various embodiments of the disclosure;

FIG. 3A and FIG. 3B present a bottom perspective view and a top perspective view, respectively, of a common trip link actuator, according to various embodiments of this disclosure;

FIG. 4A and FIG. 4B present a top perspective view and a bottom perspective view, respectively, of a common trip link, according to various embodiments of this disclosure;

FIG. 5A and FIG. 5B present a bottom perspective view in whole and in part, respectively, of a fuse carrier, according to various embodiments of this disclosure;

FIG. 6 shows another fused disconnect switch in cross-section, according to various embodiments of the disclosure;

FIG. 7 Depicts a 3 pole fused disconnect switch in perspective view, according to various embodiments of this disclosure;

FIG. 8A and FIG. 8B present alternative top perspective views of a ground fault circuit interrupter module, according to some embodiments of the disclosure;

FIG. 9A presents a top perspective views of a disconnect module, according to some embodiments of the disclosure;

FIG. 9B presents a bottom perspective views of the disconnect module of FIG. 9A; and

FIG. 10 shows a fuse carrier according to additional embodiments of the disclosure.

### DESCRIPTION OF EMBODIMENTS

The present embodiments will now be described more fully hereinafter with reference to the accompanying drawings, in which exemplary embodiments are shown. The embodiments are not to be construed as limited to the embodiments set forth herein. Rather, these embodiments are provided so that this disclosure will be thorough and complete, and will fully convey their scope to those skilled in the art. In the drawings, like numbers refer to like elements throughout.

In the following description and/or claims, the terms “on,” “overlying,” “disposed on” and “over” may be used in the following description and claims. “On,” “overlying,” “disposed on” and “over” may be used to indicate that two or more elements are in direct physical contact with one another. Also, the term “on,”, “overlying,” “disposed on,” and “over”, may mean that two or more elements are not in direct contact with one another. For example, “over” may mean that one element is above another element while not contacting one another and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

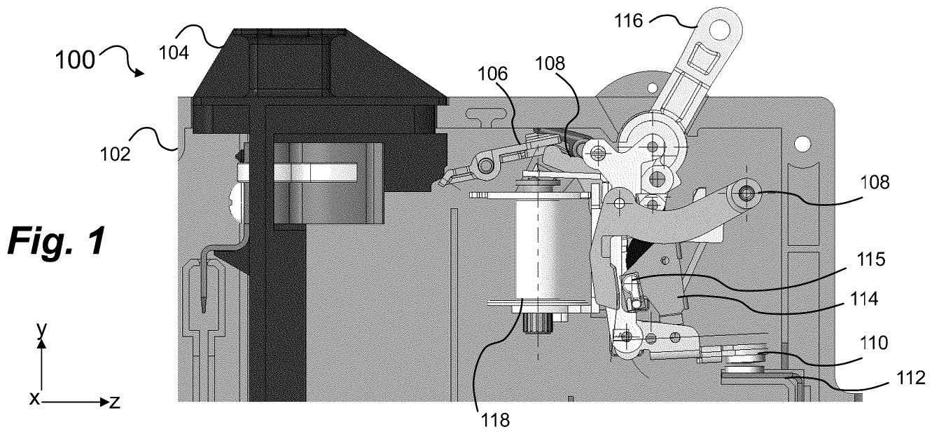

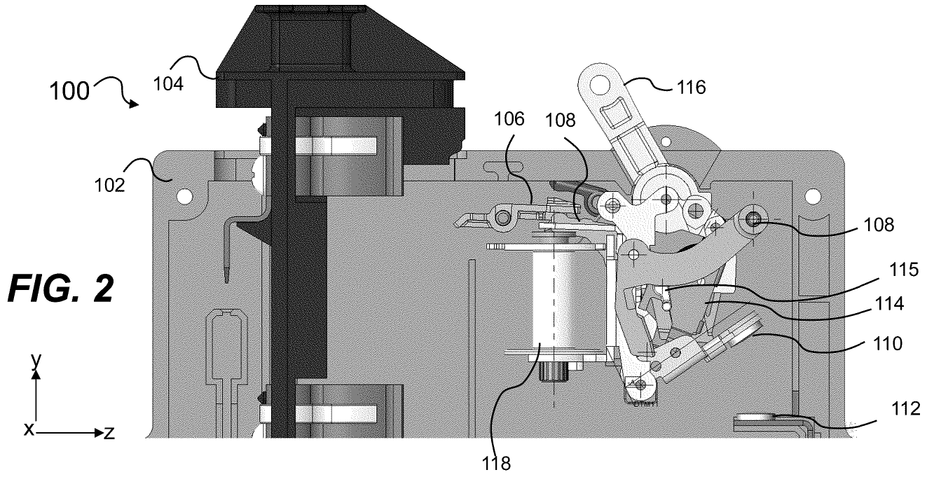

FIG. 1 shows a cross-sectional view of a fused disconnect switch 100 in a first configuration, according to various embodiments of the disclosure. FIG. 2 shows the fused disconnect switch 100 of FIG. 1 in a second configuration, according to various embodiments of the disclosure.

Referring again to FIG. 1, the fused disconnect switch 100 includes a housing 102 and a fuse carrier 104, to house a fuse. In the present embodiments, the fuse carrier 104 is movable and in particular is designed for reversible movement with respect to the housing 102 during routine use, between an engaged position, shown in FIG. 1, and a disengaged position, shown in FIG. 2. Note that a fuse is not shown in these images for simplicity of illustration. The fused disconnect switch 100 further includes an actuator 106 that is configured to reversibly engage and disengage with the fuse carrier 104. In the view of FIG. 1, the fuse carrier 104 is engaged with the actuator 106 so as to move a left side of the actuator downwardly as shown. The fused disconnect switch 100 further includes a common trip link 108, arranged to reversibly engage and disengage with the actuator 106, and a contact arm 110 that is indirectly mechanically coupled to the common trip link 108 With reference also to FIG. 2, the aforementioned components of the fused disconnect switch 100 are mutually arranged such that, when the fuse carrier 104 is disposed in the engaged position, the contact arm 110 is free to move into a closed position to make electrical contact with a fixed contact 112, as illustrated in FIG. 1.

Moreover, when the fuse carrier 104 is in a disengaged position, represented by FIG. 2, the contact arm 110 is prevented from moving into the closed position, and thus cannot make electrical contact with the fixed contact 112. In particular, in the illustration of FIG. 2, the fuse carrier 104 is moved to the disengaged position, such as when loading or unloading a fuse, and reset handle 116 has been moved to the left. Nevertheless, the contact arm 110 is prevented from moving downwardly to make contact with the fixed contact 112 because an escapement assembly 114 is held in an open position by the common trip link 108 when the fuse carrier 104 is disengaged as shown. The common trip link 108 is rotated in a counterclockwise fashion with respect to the configuration of FIG. 1, and thus blocks the escapement assembly 114 from allowing the contact arm to move downwardly to connect to the fixed contact 112. The escapement assembly 114 may function as in known escapement mechanisms of known circuit breakers and will not be explained in complete detail herein. However, generally when the lower arm 108B of the common trip link 108 is moved counter clockwise (compare FIG. 1 and FIG. 2), it makes contact with an escapement lock 115, which triggers the escapement/trip.

Moreover, because of the arrangement of the various components of the fuse disconnect switch 100, removal of the fuse carrier 104, while the contact arm 110 is in a closed position, will cause the actuator 106 to trigger the common trip link 108 and disconnect the contact arm 110. Thus, the fused disconnect switch provides for facile and safe fuse changing as needed.

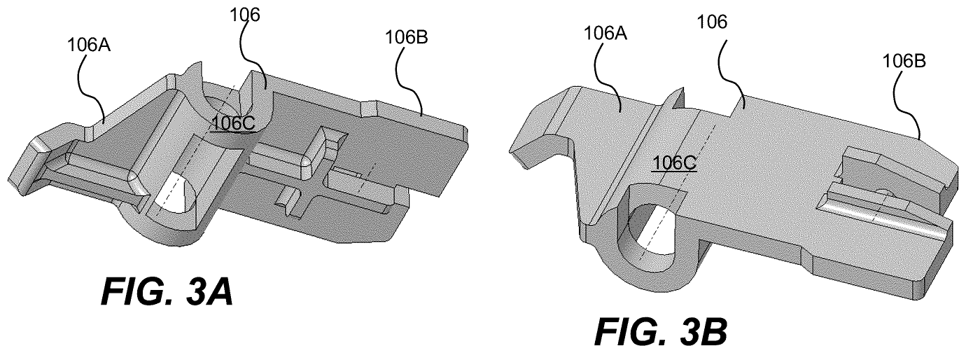

FIG. 3A and FIG. 3B present a bottom perspective view and a top perspective view, respectively, of an embodiment of the actuator 106. In these views, the actuator 106 is seen to include a first arm 106A to engage a surface of the fuse carrier 104, and further comprises a second arm 106B that is biased against the common trip link 108. The actuator 106 includes a middle portion 106C that has the shape of a hollow cylinder to provide a rotation axis for pivoting the actuator 106 about a rotation axis (x-axis of the Cartesian coordinate system shown), as the fuse carrier moves from the engage to disengaged position (compare FIG. 1 to FIG. 2).

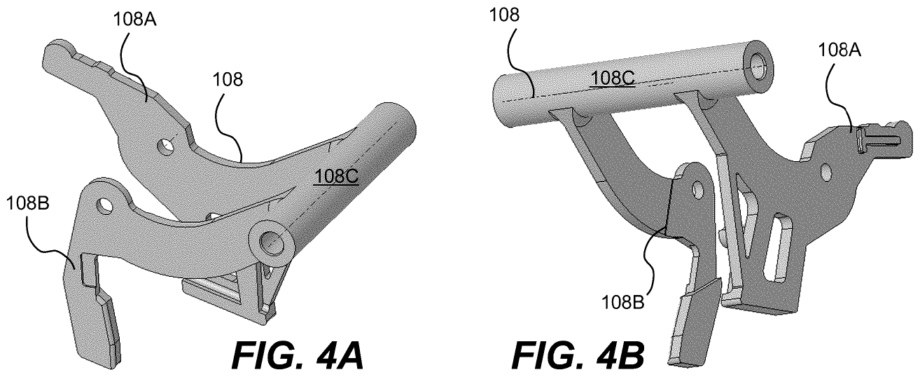

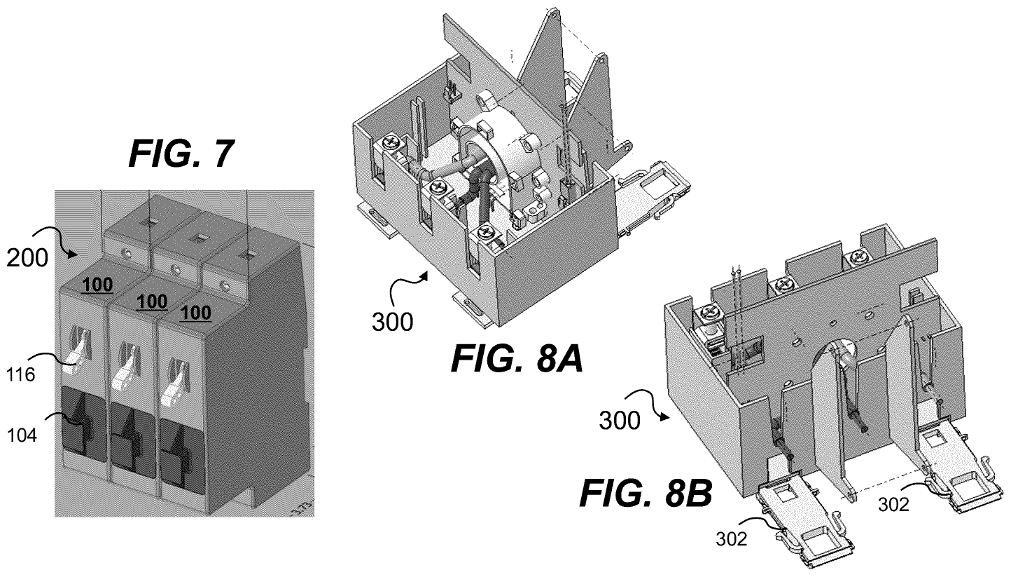

FIG. 4A and FIG. 4B present a top perspective view and a bottom perspective view, respectively, of an embodiment of the common trip link 108. As shown, the common trip link 108 comprises an upper arm 108A to engage the second arm 106B of the actuator 106, and a lower arm 108B to engage the escapement assembly 114. Note that the middle portion 106C, having a hollow cylindrical shape, allows the common trip link 108 to be mechanically coupled to additional common trip links for embodiments of multi-pole fuse disconnect switches. In particular, a coupler (not separately shown) is provided to mechanically link each trip link to each other trip link in a multi-pole fuse disconnect switch (see, e.g., FIG. 7), so that if any pole in the multipole fuse disconnect switch is tripped, then all poles are tripped.

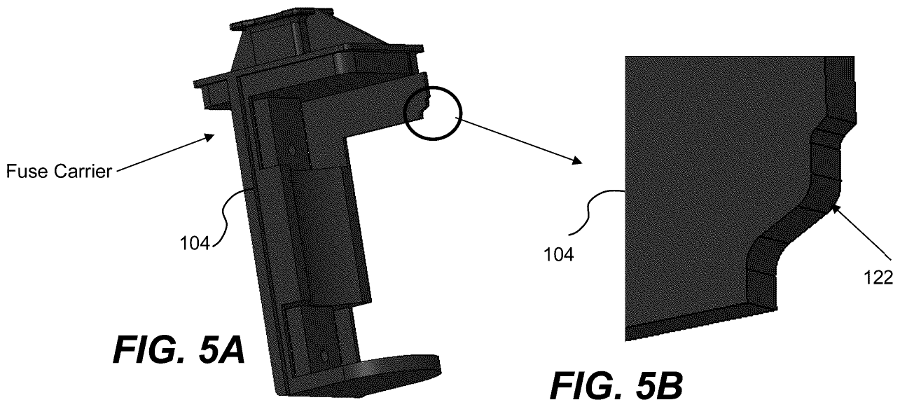

FIG. 5A and FIG. 5B present a bottom perspective view in whole and in part, respectively, of an embodiment of the fuse carrier 104, according to various embodiments of this disclosure. The fuse carrier 104 includes a cam surface 122 that is arranged to engage the actuator 106 so that the actuator 106 will pivot around its rotation axis as the fuse carrier 104 moves from the engaged to disengaged position.

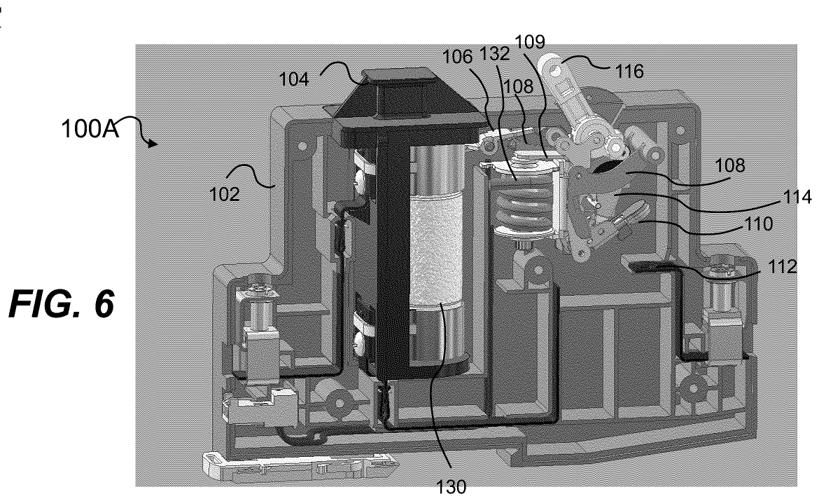

FIG. 6 shows another fused disconnect switch in cross-section, according to various embodiments of the disclosure. In this embodiment, the fused disconnect switch 100A may be deemed to be slight variant of the fused disconnect switch 100, with like parts labeled the same. Thus, the fused disconnect switch 100 includes a housing 102, fuse carrier 104, actuator 106, a common trip link 108, mechanically coupled to the actuator 106, and a contact arm 110, fixed contact 112 and escapement assembly 114. The fused disconnect switch 100A may also include a shunt trip coil 132. In various embodiments, the shunt trip coil 132 will include an armature of a hydraulic-magnetic circuit breaker mechanism. In the particular embodiment depicted in FIG. 6, the shunt trip coil 132, when energized, is arranged to magnetically couple to an armature 109 that is mechanically coupled to the escapement assembly 114. The shunt trip coil 132 is arranged to receive an external control voltage to reversibly disconnect the contact arm 110. Thus, the contact arm 110 may be disengaged from the fixed contact 112 by an external signal provided to the shunt trip coil 132, by engaging a user-controlled mechanism external to the housing 102. Thus, a remote trip capability is provided using the shunt trip coil 132.

Note also that in the view of FIG. 6, it may be appreciated that the fuse carrier 104 is disposed with a fuse 130 contained therein, as in arranged in an engaged position. Thus, the actuator 106 is rotated in a counterclockwise direction away from the common trip link 108, such that the common trip link 108 and contact arm 110 are free to rotate in a clockwise direction when the reset handle is likewise rotated in the clockwise direction. Thus, with the fuse 130 in place in the fuse carrier 104 in the engaged position, the contact arm 110 is able to make electrical contact with the fixed contact 112.

FIG. 7 depicts a 3 pole fused disconnect switch 200 in perspective view, according to various embodiments of this disclosure. The three pole fused disconnect switch 200 may include an assembly of three of the fused disconnect switches 100, or similar switches as disclosed herein. Each of the fused disconnect switches 100 may be coupled to a different conductor or wire in a three phase power system, where an AC signal is conducted along the three different wires with 120 degree phase stagger between the AC signal conducted on a given wire and each other wire. Thus, the 3 pole fused disconnect switch 200 may operate on all three phases of a three phase system to provide fused disconnect capability for each phase. In the example of FIG. 7, the three different ones of the fused disconnect switches 100 may be affixed to one another so that the 3 pole fused disconnect switch 200 may be readily coupled to a separate relay component, such as a voltage monitor and/or a GFCI module.

FIG. 8A and FIG. 8B present alternative top perspective views of a relay module 300, according to some embodiments of the disclosure. The relay module 300 may include coupling extensions 302, for fastening to a fused disconnect module, such as the 3 pole fused disconnect switch 200.

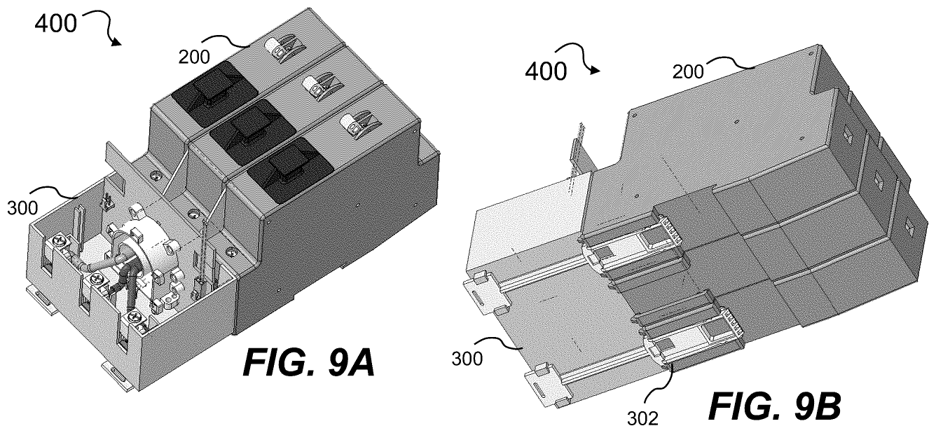

FIG. 9A presents a top perspective views of a disconnect module 400, according to some embodiments of the disclosure. FIG. 9B presents a bottom perspective views of the disconnect module of FIG. 9A; The disconnect module 400 includes the 3 pole fused disconnect switch 200, and relay module 300, which components are fastened to one another using the coupling extensions 302, as shown in FIG. 9B. The disconnect module 400 provides a novel architecture where the same fused disconnect switch may be configured to be conjoined with a relay module both electrically and mechanically. According to various embodiments of the disclosure, the relay module may be equipped with sensing and control elements similar to those elements used in known voltage monitors, ground fault relays, or ground fault circuit interrupters.

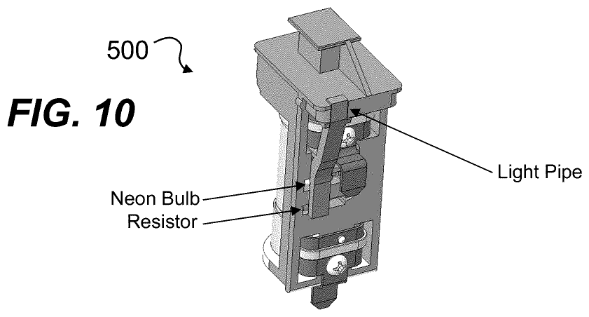

FIG. 10 shows a fuse carrier 500 according to additional embodiments of the disclosure. The fuse carrier 500 may be configured for use in the fused disconnect switch 100 or fused disconnect switch 100A, for example. The fuse carrier 500 includes a resistor, a light bulb, and a light pipe, to generate an indicator signal when the fuse in the fuse carrier 500 is blown, in order to eliminate any hazardous voltage potential at the face of the fuse carrier 500 or enclosure.

While the present embodiments have been disclosed with reference to certain embodiments, numerous modifications, alterations and changes to the described embodiments are possible while not departing from the sphere and scope of the present disclosure, as defined in the appended claims. Accordingly, the present embodiments are not to be limited to the described embodiments, and may have the full scope defined by the language of the following claims, and equivalents thereof.

What is claimed is:

1. A fused disconnect switch, for overcurrent protection, comprising:
a fuse carrier to house a fuse;
an actuator configured to reversibly engage and disengage with the fuse carrier;
a common trip link, mechanically coupled to move in concert with the actuator; and
a contact arm, indirectly mechanically coupled to the common trip link,
wherein, when the fuse carrier is disposed in an engaged position, the contact arm is free to move into a closed position to make electrical contact with a fixed contact, and wherein, when the fuse carrier is in a disengage position, the contact arm is prevented from moving into the closed position.

2. The fused disconnect switch of claim 1, wherein, when the fuse carrier is moved out of the engaged position while the contact arm is in contact with the fixed contact, the actuator is configured to trigger the common trip link to disconnect the contact arm from the fixed contact.

3. The fused disconnect switch of claim 1, wherein the actuator comprises a first arm to engage a surface of the fuse carrier, and further comprises a second arm that is biased against the common trip link.

4. The fused disconnect switch of claim 3, further comprising an escapement assembly, coupled between the common trip link and the contact arm, wherein the escapement assembly is held in an open position when the fuse carrier is in the disengage position.

5. The fused disconnect switch of claim 4, wherein the common trip link comprises an upper arm to engage the second arm of the actuator, and wherein the common trip link comprises a lower arm to engage the escapement assembly.

6. The fused disconnect switch of claim 4, further comprising a shunt trip coil, and an armature, wherein the shunt trip coil is arranged to receive an external voltage that magnetically couples the shunt trip coil to the armature, wherein the armature is mechanically coupled to the escapement assembly to reversibly disconnect the contact arm.

7. The fused disconnect switch of claim 1, further comprising:
a housing, arranged to enclose the fuse when the fuse carrier is disposed in the engaged position; and
a reset handle, extending externally to the housing, wherein the contact arm is prevented from moving to the closed position when the reset handle is moved from an open to closed position, when the fuse carrier is in a disengage position.

8. The fused disconnect switch of claim 1, the fuse carrier further comprising:
a resistor;
a light bulb; and
a light pipe, arranged to generate an indicator signal when a fuse in the fuse carrier is blown.

9. A disconnect module, comprising:
a relay module; and
a fused disconnect switch, coupled to the relay module, comprising:
a fuse carrier to house a fuse;
an actuator configured to reversibly engage and disengage with the fuse carrier;
a common trip link, mechanically coupled to move in concert with the actuator; and
a contact arm, indirectly mechanically coupled to the common trip link,
wherein, when the fuse carrier is disposed in an engaged position, the contact arm is free to move into a closed position to make electrical contact with a fixed contact, and wherein, when the fuse carrier is in a disengage position, the contact arm is prevented from moving into the closed position.

10. The disconnect module of claim 9, wherein, when the fuse carrier is moved out of the engaged position while the contact arm is in contact with the fixed contact, the actuator is configured to trigger the common trip link to disconnect the contact arm from the fixed contact.

11. The disconnect module of claim 9, wherein the actuator comprises a first arm to engage a surface of the fuse carrier, and further comprises a second arm that is biased against the common trip link.

12. The disconnect module of claim 11, further comprising an escapement assembly, coupled between the common trip link and the contact arm, wherein the escapement assembly is held in an open position when the fuse carrier is in the disengage position.

13. The disconnect module of claim 12, wherein the common trip link comprises an upper arm to engage the second arm of the actuator, and wherein the common trip link comprises a lower arm to engage the escapement assembly.

14. The disconnect module of claim 12, further comprising a shunt trip coil and an armature, wherein the shunt trip coil is arranged to receive an external voltage that magnetically couples the shunt trip coil to the armature, wherein the armature is mechanically coupled to the escapement assembly to reversibly disconnect the contact arm.

15. The disconnect module of claim 9, further comprising:
a housing, arranged to enclose the fuse when the fuse carrier is disposed in the engaged position; and
a reset handle, extending externally to the housing, wherein the contact arm is prevented from moving to the closed position when the reset handle is moved from an open to closed position, when the fuse carrier is in a disengage position.

16. The disconnect module of claim 9, the fuse carrier further comprising:
a resistor;
a light bulb; and
a light pipe, arranged to generate an indicator signal when a fuse in the fuse carrier is blown.

17. The disconnect module of claim 9, further comprising a second fused disconnect switch, coupled to the relay module, wherein the actuator comprises a middle portion, having a shape that is arranged to mechanically couple to a second trip link actuator of the second fused disconnect switch.
